(19) United States
(12) Patent Application Publication
(10) Pub. No.: US 2019/0218443 A1
(43) Pub. Date: Jul. 18, 2019

(54) LUBRICANT FOR WATER BASED MUD (WBM) WITH HIGH SALT TOLERANCE FOR HIGH TEMPERATURE AND HIGH PRESSURE FORMATION

(71) Applicant: CNPC USA Corporation, Houston, TX (US)

(72) Inventors: Bruno Hoxha, Houston, TX (US); Meng Lu, Sugar Land, TX (US); Janine M. Shipman, Pearland, TX (US)

(73) Assignee: CNPC USA Corporation, Houston, TX (US)

(21) Appl. No.: 15/869,670

(22) Filed: Jan. 12, 2018

(51) Int. Cl. C09K 8/12

(52) U.S. Cl. CPC C09K 8/12; C09K 2208/34

(57) ABSTRACT

Friction forces pose a danger to wellbore formation integrity, equipment stress, and success of the drilling operation. Friction forces in the wellbore can be managed by adding lubricants into drilling fluids. Lubricants reduce torque and drag friction forces on the drillstring, and improve the rate of penetration (ROP) during operation of the wellbore. Polyalkylene glycol lubricant with structure R—(OCH₂CH₂)ₘ—(OCH(CH₃)CH₂)ₙ—OH can be used for water-based drilling fluids. Polyalkylene glycol coats metal surfaces and creates a lubricating layer to reduce torque and drag. Adding polyalkylene glycol to high density water-based drilling fluids is an effective method for reducing frictional forces during HPHT and high salinity drilling applications.

### FIELD

The disclosure relates generally to water-based drilling fluid additives. The disclosure relates specifically to additives for increasing lubricity of water-based drilling fluids.

### BACKGROUND

Friction forces pose a danger to wellbore formation integrity, equipment stress, and success of the drilling operation. Friction forces in the wellbore can be managed by adding lubricants into drilling fluids. Lubricants reduce torque and drag friction forces on the drillstring, and improve the rate of penetration (ROP) during operation of the wellbore.

Water-based drilling fluids are considered to be more economically and environmentally conscious solutions relative to oil-based drilling fluids. However, water-based drilling fluids are more susceptible to degradation, low viscosity, and fluid-loss under high pressure and temperature (HPHT) or high salinity conditions.

It would be advantageous to develop a lubricant to improve the lubricity of high performance, high density water-based drilling fluids, particularly for HPHT and high salinity applications.

Disclosed herein is the use of polyalkylene glycol as a lubricant for water-based drilling fluids. Polyalkylene glycol coats metal surfaces and creates a lubricating layer to reduce torque and drag. Adding polyalkylene glycol to high density water-based drilling fluids is an effective method for reducing frictional forces during HPHT and high salinity drilling applications.

### SUMMARY

An embodiment of the disclosure is a method of increasing lubricity of a water-based drilling fluid comprising adding 1-3% polyalkylene glycol to the water-based drilling fluid to form a water-based drilling fluid composition. In an embodiment, In an embodiment, the polyalkylene glycol is of a structure R—(OCH2CH2)m-(OCH(CH3)CH2)n-OH wherein: R is a saturated alkyl group with up to six carbon atoms; m and n are integers the ratio of m over n (m/n) is 0.2-5, preferably 0.5-2 and the molecular weight is 1000-5000 g/mol. In an embodiment, the polyalkylene glycol is of the structure wherein: R is a saturated alkyl group with 4-6 carbon atoms; m and n are integers the ratio of m over n (m/n) is 0.2-5, preferably 0.5-2; and the molecular weight is 2000-5000 g/mol. In an embodiment, the water-based drilling fluid further comprises at least 150,000 mg/L Cl—. In an embodiment, density of the water-based drilling fluid is at least 15 ppg. In an embodiment, the water-based drilling fluid composition has a coefficient of friction that is decreased by up to 32% after addition of the polyethylene glycol. In an embodiment, the torque is decreased by up to 32% after addition of the polyethylene glycol. In an embodiment, the water-based drilling fluid composition further comprises: 1-5 ppb polymer; 1-1.5 ppb temperature extender; 350-450 ppb barium sulfate; and 10-14 ppb blended calcium carbonate.

An embodiment of the disclosure is a water-based drilling fluid composition comprising 1-3% polyalkylene glycol of a structure R—(OCH2CH2)m-(OCH(CH3)CH2)n-OH wherein: R is a saturated alkyl group with up to six carbon atoms; m and n are integers the ratio of m over n (m/n) is 0.2-5, preferably 0.5-2; the molecular weight is 1000-5000 g/mol; and lubricity of the drilling fluid is increased after addition of polyalkylene glycol. In an embodiment, the polyalkylene glycol is of the structure wherein: R is a saturated alkyl group with 4-6 carbon atoms; m and n are integers the ratio of m over n (m/n) is 0.2-5, preferably 0.5-2; and the molecular weight is 2000-5000 g/mol. In an embodiment, the composition further comprises at least 150,000 mg/L Cl—. In an embodiment, the density of the water-based drilling fluid is at least 15 ppg. In an embodiment, the water-based drilling fluid composition has a coefficient of friction that is decreased by up to 32% after addition of the polyethylene glycol. In an embodiment, the torque is decreased by up to 32% after addition of the polyethylene glycol. In an embodiment, the composition further comprises 1-5 ppb polymer; 1-1.5 ppb temperature extender; 350-450 ppb barium sulfate; and 10-14 ppb blended calcium carbonate.

An embodiment of the disclosure is a wellbore comprising a water-based drilling fluid composition comprising 1-3% polyalkylene glycol of a structure R—(OCH2CH2)m-(OCH(CH3)CH2)n-OH wherein: R is a saturated alkyl group with up to six carbon atoms; m and n are integers the ratio of m over n (m/n) is 0.2-5, preferably 0.5-2; the molecular weight is 1000-5000 g/mol; and lubricity of the drilling fluid in the wellbore is increased after addition of polyalkylene glycol. In an embodiment, the polyalkylene glycol is of the structure wherein: R is a saturated alkyl group with 4-6 carbon atoms; m and n are integers the ratio of m over n (m/n) is 0.2-5, preferably 0.5-2; and the molecular weight is 2000-5000 g/mol. In an embodiment, the temperature of the wellbore is at least 325° F. In an embodiment, the water-based drilling fluid is at least 15 ppg. In an embodiment, the water-based drilling fluid composition has a coefficient of friction that is decreased by up to 32% after addition of the polyethylene glycol.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 Lubricity reading of 16.5 ppb drilling fluid with 20% NaCl after hot rolling at 350° F.

FIG. 2 Torque reduction of 16.5 ppg drilling fluid with 20% NaCl after hot rolling at 350° F.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

As used herein, the term “lubricant” means and refers to agents used to reduce the coefficient of friction of drilling fluids. Lubricants reduce torque and drag on the drillstring, and increase the rate of penetration (ROP).

Lubricants are one of the components used in water base drilling fluids to reduce the friction forces during drilling or pulling out of the hole. The lubricant reduces torque and drag, and improves the rate of penetration (ROP). The purpose of this invention is to improve the lubricity coefficient of high performance water based drilling fluids, particularly for high temperature, high pressure, high salt concentration or high density applications.

Polyalkylene glycol can be used as a lubricant for water-based drilling fluids. Polyalkylene glycol coats metal surfaces and creates a lubricating layer to reduce torque and drag when added to water based drilling fluids, and is effective for high temperature (greater than 325° F.) and high pressure applications (500 psi). This product can also be used in drilling fluids with high salinity (greater than 150,000 mg/L Cl—).

We disclosed the use of polyalkylene glycol with a structure shown below (R—(OCH2CH2)m-(OCH(CH3)CH2)n-OH):

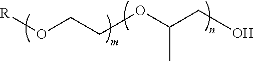

wherein:
R is a saturated alkyl group with up to six carbon atoms, preferably 4-6 carbon atoms;
m and n are integers the ratio of m over n (m/n) is 0.2-5, preferably 0.5-2
the molecular weight is 1000-5000 g/mol, preferably 2000-5000.

Dynamic aging can be used to test the rheology of water-based drilling fluids in response to lubricants and other additives at high temperature and pressure. In an embodiment, the coefficient of friction of a high salinity, high density water-based drilling fluid is reduced up to 32% and torque is reduced up to 31.48 in response to polyalkylene glycol.

Additives may be added in combination with the lubricant to further improve the rheology of drilling fluids. Bridging agents may be added to prevent fluid loss. Viscosifiers or deflocculants may be used to control viscosity of the drilling fluid. Weighting agents may be added to maintain integrity of the wellbore. Temperature extender can be added to maintain the temperature stability of the drilling fluids.

The use of polyether chemistry disclosed in this invention could provide excellent lubricity and friction reducing torque and drag for use in water-based drilling fluids at high temperature, high pressure, high density, and high salinity.

### EXAMPLES

### Example 1

Experimental high salinity, high density water-based drilling fluids were prepared for testing with polyalkylene glycol (Table 1). The base mud comprised 50.5 ppb NaCl and 17.0 ppb KCl components were prepared. Two polymers were added to the fluids at 1.0 ppb and 4.0 ppb, respectively: crosslinked acrylamide terpolymer and acrylamide copolymer in inverse emulsion.

TABLE 1
Formulation of experimental water-based drilling
fluids with mud weight of 16.5 ppg.

| | |
|---|---|
| Top Water, ppb | 207.00 |
| NaCl, ppb | 50.5 |
| NaOH, ppb | 0.75-1.00 |
| KCl, ppb | 17.00 |
| Polymer 1, ppb | 1.0 |
| Polymer 2, ppb | 4.00 |
| Lubricant, % v/v | 1-3 |
| Temperature extender, ppb | 1-1.5 |
| BaSO4, ppb | 400-410 |
| Blend CaCO3, ppb | 10-14 |
| Volume, cm3 | 350 |
| Mud Weight, ppg . . . gr/cm3 | 16.5 |

Blended bridging agents sized calcium carbonate was added to the water-based drilling fluid at 10-14 ppb to improve HPHT fluid loss. 400-410 ppb barite was added as a weighting agent. Other additives could be added to further improve rheology.

The final mud weight of the water-based drilling fluid is 16.5 ppg.

### Example 2

The water-based drilling fluid was subjected to standard testing after dynamic aging to determine rheological properties, fluid loss properties and coefficient of friction in response to polyalkylene glycol lubricants. Dynamic aging was performed at 350° F. for 16 hours following API testing procedures. Samples were mixed with 20% NaCl to increase salinity to at least 150,000 mg/L Cl—. The results are in Table 2.

TABLE 2
Properties of 16.5 ppg experimental water-based drilling
fluids after aging at 350° F. for 16 hours.

| | Base Mud | Lub. 1 | Lub. 2 | Lub. 3 |
|---|---|---|---|---|
| HR at 357 F. | AHR | AHR | AHR | AHR |
| 600 rpm | 163.1 | 174 | 166.2 | 194.1 |
| 300 rpm | 94 | 100.4 | 95.9 | 111.5 |
| 200 rpm | 68.7 | 72.8 | 70 | 80.9 |
| 100 rpm | 40.7 | 42.7 | 41.2 | 47.5 |
| 6 rpm | 8.4 | 7.2 | 7.1 | 9.1 |
| 3 rpm | 6.8 | 5.9 | 5.4 | 7.1 |
| GELS 10″ | 4.4 | 4 | 3.8 | 5.7 |
| GELS 10′ | 11.3 | 11.3 | 10.3 | 13.8 |
| PLASTC VISC. | 69.1 | 73.6 | 70.3 | 82.6 |
| YIELD POINT | 24.9 | 26.8 | 25.6 | 28.9 |
| pH | 9.44 | 9.53 | 9.52 | 9.46 |

TABLE 3
Lubricity Readings

| | Time | | | | |
|---|---|---|---|---|---|
| | (minutes) | Base Mud | Lub. 1 | Lub. 2 | Lub. 3 |
| Lubricity | 3 | 10.4 | 10.6 | 9.2 | 7.2 |
| Reading | 4 | 10.1 | 10.5 | 8.5 | 6.9 |
| | 5 | 10 | 10.1 | 7.7 | 6.8 |

In an embodiment, Lub 1, Lub 2, and Lub 3 have different molecular weights. In an embodiment, the molecular weight of Lub.1 is 750 gr/mol, Lub 2 is 1590 gr/mol, and Lub 3 is 3930 gr/mol. In an embodiment, the molecular weight of the lubricant is 2000-5000 gr/mol, DIW=de-ionized water.

The addition of polyalkylene glycol in water-based drilling fluids effectively decreased coefficient of friction and torque.

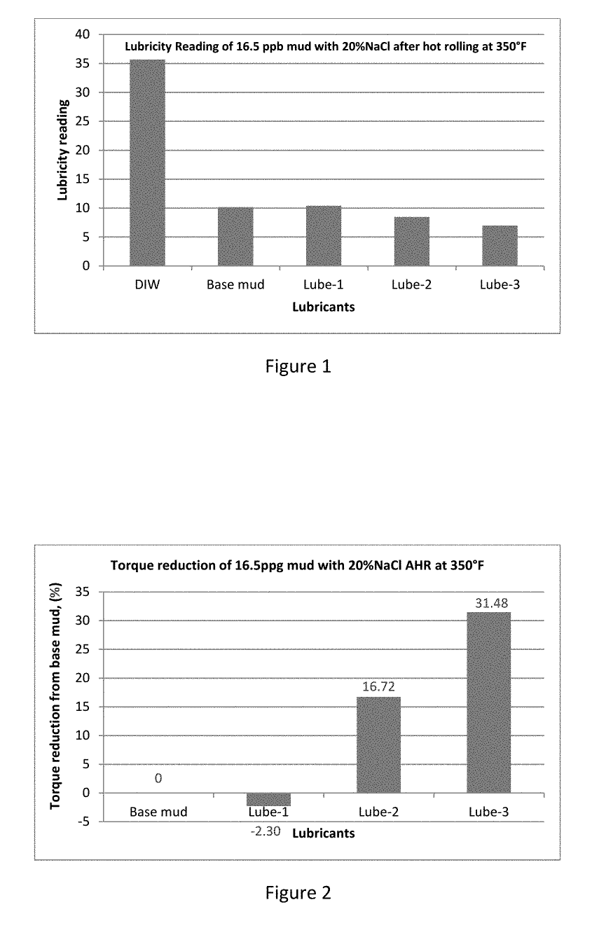

FIG. 1 plots the coefficient of friction of the drilling fluids after hot rolling at 350° F. for 16 hours at high salinity. Lubricant #3 yielded the best results, reducing the coefficient of friction from 10.17 to 6.97 on average (32% reduction). Lubricant #2 reduced coefficient of friction to 8.47 on average (17% reduction). Table 3 depict the lubricity readings over time for the base mud and Lub 1, Lub 2, and Lub 3.

FIG. 2 plots the reduction in torque measured for the drilling fluids after hot rolling at 350° F. for 16 hours at high salinity. Lubricant #3 again yielded the best results, reducing torque by 31.48%. Lubricant #2 reduced torque by 16.72%.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the disclosure as defined by the appended claims.

What is claimed is:

1. A method of increasing lubricity of a water-based drilling fluid comprising adding 1-3% polyalkylene glycol to the water-based drilling fluid to form a water-based drilling fluid composition.

2. The method of claim 1 wherein the polyalkylene glycol is of a structure R—(OCH₂CH₂)ₘ—(OCH(CH₃)CH₂)ₙ—OH wherein:
R is a saturated alkyl group with up to six carbon atoms;
m and n are integers the ratio of m over n (m/n) is 0.2-5, preferably 0.5-2 and
the molecular weight is 1000-5000 g/mol.

3. The method of claim 2 wherein the polyalkylene glycol is of the structure wherein:
R is a saturated alkyl group with 4-6 carbon atoms;
m and n are integers the ratio of m over n (m/n) is 0.2-5, preferably 0.5-2; and
the molecular weight is 2000-5000 g/mol.

4. The method of claim 2 wherein the water-based drilling fluid further comprises at least 150,000 mg/L Cl⁻.

5. The method of claim 2 wherein density of the water-based drilling fluid is at least 15 ppg.

6. The method of claim 2 wherein the water-based drilling fluid composition has a coefficient of friction that is decreased by up to 32% after addition of the polyethylene glycol.

7. The method of claim 2 wherein the torque is decreased by up to 32% after addition of the polyethylene glycol.

8. The method of claim 2 wherein the water-based drilling fluid composition further comprises:
1-5 ppb polymer;
1-1.5 ppb temperature extender;
350-450 ppb barium sulfate; and
10-14 ppb blended calcium carbonate.

9. A water-based drilling fluid composition comprising 1-3% polyalkylene glycol of a structure R—(OCH₂CH₂)ₘ—(OCH(CH₃)CH₂)ₙ—OH wherein:
R is a saturated alkyl group with up to six carbon atoms;
m and n are integers the ratio of m over n (m/n) is 0.2-5, preferably 0.5-2;
the molecular weight is 1000-5000 g/mol; and
lubricity of the drilling fluid is increased after addition of polyalkylene glycol.

10. The composition of claim 9, wherein the polyalkylene glycol is of the structure wherein:
R is a saturated alkyl group with 4-6 carbon atoms;
m and n are integers the ratio of m over n (m/n) is 0.2-5, preferably 0.5-2; and
the molecular weight is 2000-5000 g/mol.

11. The composition of claim 9 further comprising at least 150,000 mg/L Cl⁻.

12. The composition of claim 9 wherein the density of the water-based drilling fluid is at least 15 ppg.

13. The composition of claim 9 wherein the water-based drilling fluid composition has a coefficient of friction that is decreased by up to 32% after addition of the polyethylene glycol.

14. The composition of claim 9 wherein the torque is decreased by up to 32% after addition of the polyethylene glycol.

15. The composition of claim 9 further comprising:
1-5 ppb polymer;
1-1.5 ppb temperature extender;
350-450 ppb barium sulfate; and
10-14 ppb blended calcium carbonate.

16. A wellbore comprising a water-based drilling fluid composition comprising 1-3% polyalkylene glycol of a structure R—(OCH₂CH₂)ₘ—(OCH(CH₃)CH₂)ₙ—OH wherein:
R is a saturated alkyl group with up to six carbon atoms;
m and n are integers the ratio of m over n (m/n) is 0.2-5, preferably 0.5-2;
the molecular weight is 1000-5000 g/mol; and
lubricity of the drilling fluid in the wellbore is increased after addition of polyalkylene glycol.

17. The wellbore of claim 16, wherein the polyalkylene glycol is of the structure wherein:
R is a saturated alkyl group with 4-6 carbon atoms;
m and n are integers the ratio of m over n (m/n) is 0.2-5, preferably 0.5-2; and
the molecular weight is 2000-5000 g/mol.

18. The wellbore of claim 16 wherein the temperature of the wellbore is at least 325° F.

19. The wellbore of claim 16 wherein the density of the water-based drilling fluid is at least 15 ppg.

20. The wellbore of claim 16 wherein the water-based drilling fluid composition has a coefficient of friction that is decreased by up to 32% after addition of the polyethylene glycol.
